(19) United States
(12) Patent Application Publication
(10) Pub. No.: US 2025/0364598 A1
(43) Pub. Date: Nov. 27, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sohee KIM, Yongin-si (KR); SANGHOON KIM, Yongin-si (KR); HYUNBONG CHOI, Yongin-si (KR); Sangwoo PARK, Yongin-si (KR); Hongryeol PARK, Yongin-si (KR); Yeji YANG, Yongin-si (KR); Dasol JUN, Yongin-si (KR)

(73) Assignee: SAMSUNG SDI CO., LTD., Yongin-si (KR)

(21) Appl. No.: 19/175,488

(22) Filed: Apr. 10, 2025

(30) Foreign Application Priority Data
May 23, 2024 (KR) 10-2024-0066832

(51) Int. Cl. H01M 10/0567; H01M 10/0525; H01M 10/0568; H01M 10/0569; H01M 10/42

(52) U.S. Cl. CPC H01M 10/0567; H01M 10/0525; H01M 10/0568; H01M 10/0569; H01M 10/4235; H01M 2300/004

(57) ABSTRACT

Disclosed are electrolyte, electrolyte additives, and rechargeable lithium batteries. The electrolyte comprises a non-aqueous organic solvent, a lithium salt, and an additive. The additive includes a first compound represented by Chemical Formula 1 and a second compound represented by Chemical Formula 2. A detailed description of Chemical Formulae 1 and 2 is provided in this disclosure.

### CROSS-REFERENCE TO RELATED APPLICATION

This U.S. nonprovisional application claims priority under 35 U.S.C § 119 to Korean Patent Application No. 10-2024-0066832 filed on May 23, 2024 in the Korean Intellectual Property Office, the disclosure of which is hereby incorporated by reference in its entirety.

### BACKGROUND

The present disclosure relates to an electrolyte for a rechargeable lithium battery, and a rechargeable lithium battery including the electrolyte.

With increasing spread of battery using electronic devices, such as, e.g., mobile phones, laptop computers, electric vehicles, and the like, there is increasing demand for rechargeable batteries with high energy density and high capacity.

A rechargeable lithium battery typically includes a positive electrode, a negative electrode, and an electrolyte, the positive and negative electrodes include an active material in which intercalation and deintercalation are possible, and generates electrical energy caused by oxidation and reduction reactions when lithium ions are intercalated and deintercalated.

A lithium salt dissolved in a non-aqueous organic solvent may be or constitute the electrolyte of the rechargeable lithium battery. Characteristics of the rechargeable lithium battery are exhibited by complex reactions between the positive electrode and the electrolyte, and between the negative electrode and the electrolyte. Accordingly, the use of an appropriate electrolyte is a compelling factor in the improvement of the rechargeable lithium battery.

### SUMMARY

An example embodiment of the present disclosure includes an electrolyte for a rechargeable lithium battery having the effect of reducing or suppressing a resistance increase rate, and improving battery lifetime characteristics. The effect may become more pronounced at high temperatures.

An example embodiment of the present disclosure includes a rechargeable lithium battery including the electrolyte.

According to an example embodiment of the present disclosure, an electrolyte for a rechargeable lithium battery may include a non-aqueous organic solvent, a lithium salt, and an additive.

The additive may include a first compound represented by Chemical Formula 1, and a second compound represented by Chemical Formula 2.

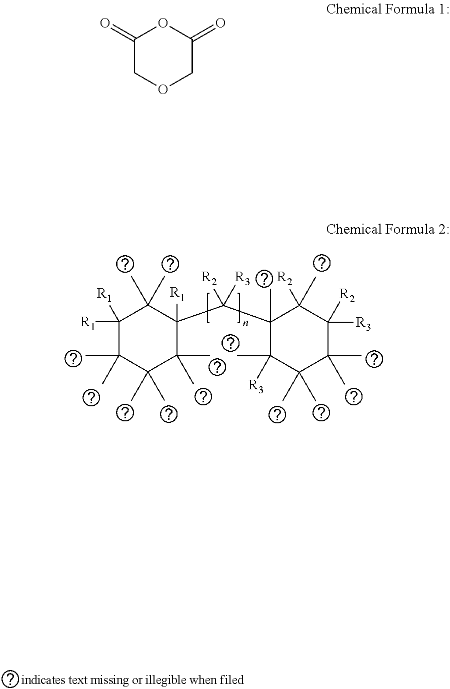

In Chemical Formula 2,

The R₁ radicals may be identical or different and may each independently be hydrogen, halogen, a C1 to C10 alkyl group, or an isocyanate group.

At least one of R₁ may be or include an isocyanate group.

The R₂ radicals may be identical or different and may each independently be hydrogen, halogen, a C1 to C10 alkyl group, or an isocyanate group.

At least one of R₂ may be or include an isocyanate group.

The R₃ radicals may be identical or different and may each independently be hydrogen or a cyclohexyl isocyanate residue.

The subscript n may be an integer in a range of 1 to 10.

According to an example embodiment of the present disclosure, a rechargeable lithium battery may include a positive electrode that includes a positive electrode active material, a negative electrode that includes a negative electrode active material, and the electrolyte for the rechargeable lithium battery.

### BRIEF DESCRIPTION OF DRAWINGS

FIG. 1 illustrates a simplified conceptual diagram illustrating a rechargeable lithium battery according to an example embodiment of the present disclosure.

FIGS. 2 to 5 are simplified diagrams illustrating a rechargeable lithium battery according to an example embodiment, in which FIG. 2 shows a cylindrical battery, FIG. 3 shows a prismatic battery, and FIGS. 4 and 5 show pouch-type batteries.

### DETAILED DESCRIPTION

In order to sufficiently understand the configuration and effect of the present disclosure, some example embodiments of the present disclosure will be described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it will be understood that, when an element is referred to as being “on” another element, the element can be directly on the other element or intervening elements may be present between therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and an average particle diameter (D₅₀) is calculated in the 50% standard of particle diameter distribution in the measurement device.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In detail, the term “substituted” may refer to at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. Alternatively, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluomethyl group, or a naphthyl group.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

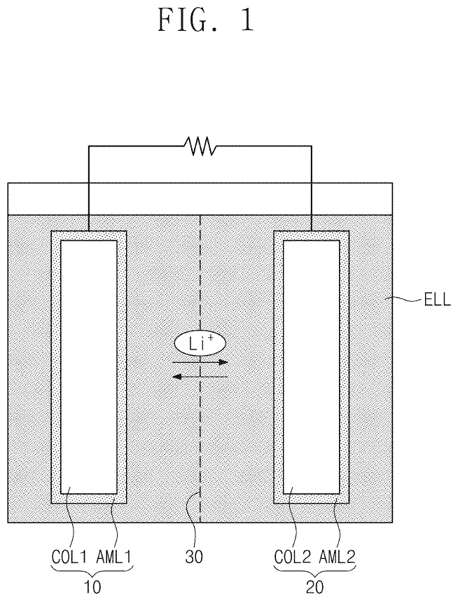

FIG. 1 illustrates a simplified conceptual diagram showing a rechargeable lithium battery according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material.

For example, the positive electrode 10 may further include an additive that can constitute a sacrificial positive electrode.

An amount of the positive electrode active material may be about 90 wt % to about 99.5 wt % relative to 100 wt % of the positive electrode active material layer AML1. An amount of each, or at least one, of the binder and the conductive material may be about 0.5 wt % to about 5 wt % relative to 100 wt % of the positive electrode active material layer AML1.

The binder may be configured to improve attachment of positive electrode active material particles to each other and also to improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be configured to provide an electrode with conductivity, and any suitable conductive material that does not cause a chemical change in a battery may be or constitute the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be or constitute the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0≤α≤2); LiₐNi_{1-b-c}Mn_{b}X_{c}O_{2-α}D_{α} (where 0.90≤a≤1.8, 0≤b≤0.5, 0≤c≤0.5, and 0≤α≤2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is or includes at least one of Ni, Co, Mn, or a combination thereof, X is or includes at least one of Al, Ni, Co, Mn, Cr, Fe, Mg, Sr, V, a rare-earth element, or a combination thereof, D is or includes at least one of O, F, S, P, or a combination thereof, G is or includes at least one of Al, Cr, Mn, Fe, Mg, La, Ce, Sr, V, or a combination thereof, and L′ is or includes at least one of Mn, Al, or a combination thereof.

For example, the positive electrode active material may be or include a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may be configured to improve attachment of negative electrode active material particles to each other, and to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be configured to provide an electrode with conductivity, and any suitable conductive material that does not cause a chemical change in a battery may be or constitute the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer on a surface of the core.

The Si-based negative electrode active material or the Sn-based negative electrode active material may be used in combination with a carbon-based negative electrode active material.

### Separator 30

Based on the type of rechargeable lithium battery, the separator 30 may be between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one or opposite surfaces of the porous substrate, the coating layer including an organic material, an inorganic material, or a combination thereof.

The porous substrate may be or include a polymer layer including a polyolefin such as or including at least one of polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be configured as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, caprolactone, or propyl propionate (PP).

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, when a carbonate-based solvent is used, a cyclic carbonate and a chain carbonate may be mixed, and the cyclic carbonate and the chain carbonate may be mixed in a volume ratio of about 1:1 to about 1:9.

The lithium salt may be or include a material that dissolves in the non-aqueous organic solvent to constitute a supply source of lithium ions in a battery, and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCI, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro(oxalato)borate(LiDFOB), lithium difluorobis (oxalato) phosphate (LiDFBOP), and lithium bis (oxalato) borate (LiBOB).

The following will describe in detail an electrolyte for a rechargeable lithium battery according to some example embodiments of the present inventive concepts.

An electrolyte for a rechargeable lithium battery according to an example embodiment may include at least one of a non-aqueous organic solvent, a lithium salt, and an additive, and the additive may include a first compound represented by Chemical Formula 1 below and a second compound represented by Chemical Formula 2 below.

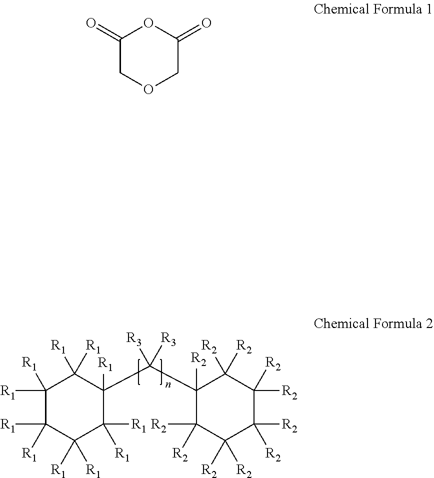

In Chemical Formula 2,

The R₁ radicals may be identical or different and may each independently be hydrogen, halogen, a C1 to C10 alkyl group, or an isocyanate group, and at least one of R₁ may be or include an isocyanate group.

The R₂ radicals may be identical or different and may each independently be hydrogen, halogen, a C1 to C10 alkyl group, or an isocyanate group, and at least one of R₂ may be or include an isocyanate group.

The R₃ radicals may be identical or different, and may each independently be hydrogen or a cyclohexyl isocyanate residue.

The subscript n may be an integer in a range of 1 to 10.

The additive will be discussed in detail below.

The electrolyte may be prepared by a mixing process in which a lithium salt is dissolved in a non-aqueous organic solvent, and the additive including compounds represented by Chemical Formulae 1 and 2 is added to mix. The electrolyte mixing process is widely known in electrolyte fabrication field, and a person skilled in the art may be able to appropriately select and use.

The non-aqueous organic solvent may include a carbonate-based solvent. In an example embodiment, the non-aqueous organic solvent may include at least one of ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In an example embodiment, the non-aqueous organic solvent may be or include a mixed solvent of at least one of ethylene carbonate (EC), ethylmethyl carbonate (EMC), and dimethyl carbonate (DMC).

In an example embodiment, the ethylene carbonate (EC) may be included in an amount of about 10 vol % to about 30 vol % relative to the total volume of the non-aqueous organic solvent. The ethylmethyl carbonate (EMC) may be included in an amount of about 30 vol % to about 50 vol % relative to the total volume of the non-aqueous organic solvent. The dimethyl carbonate (DMC) may be included in an amount of about 30 vol % to about 50 vol % relative to the total volume of the non-aqueous organic solvent. In an example embodiment, the ethylene carbonate (EC) may be included in an amount of about 15 vol % to about 25 vol % relative to the total volume of the non-aqueous organic solvent. The ethylmethyl carbonate (EMC) may be included in an amount of about 35 vol % to about 45 vol % relative to the total volume of the non-aqueous organic solvent. The dimethyl carbonate (DMC) may be included in an amount of about 35 vol % to about 45 vol % relative to the total volume of the non-aqueous organic solvent. Within any of the volume ranges above, the additive may achieve improved or optimal solubility to yield the most suitable effect.

The ethylene carbonate (EC), ethylmethyl carbonate (EMC), and dimethyl carbonate (DMC) may have a volume ratio of 1:a:b, The “a” may be in a range of 1 to 3, and the “b” may be in a range of 1 to 3. Within the volume ratio above, the additive may achieve improved or optimal solubility to yield the most suitable effect.

In an example embodiment, the lithium salt may include LiPF₆.

The lithium salt may have a concentration of about 0.1 M to about 2.0 M. For example, the lithium salt may have a concentration that is equal to or greater than about 0.5 M or equal to or greater than about 1.0 M. The lithium salt may have a concentration that is equal to or less than about 2.0 M, equal to or less than about 1.7 M, or equal to or less than about 1.5 M. In the present disclosure, when the lithium salt has a concentration of about 0.1 M to about 2.0 M, the electrolyte may appropriately maintain a conductivity and viscosity thereof.

### Additive

The additive according to the present disclosure may include a first compound represented by Chemical Formula 1 below, and a second compound represented by Chemical Formula 2 below.

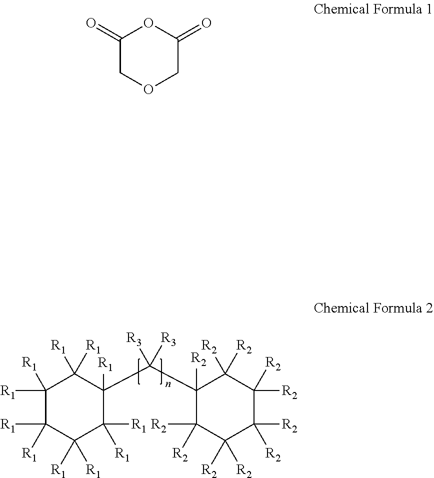

In Chemical Formula 2,

The R₁ radicals may be identical or different, and may each independently be hydrogen, halogen, a C1 to C10 alkyl group, or an isocyanate group, and at least one of R₁ may be or include an isocyanate group.

The R₂ radicals may be identical or different, and may each independently be hydrogen, halogen, a C1 to C10 alkyl group, or an isocyanate group, and at least one of R₂ may be or include an isocyanate group.

The R₃ radicals may be identical or different, and may each independently be hydrogen or a cyclohexyl isocyanate residue.

The subscript n may be an integer in a range of 1 to 10.

In an example embodiment, Chemical Formula 2 above may be represented by Chemical Formula 2-1 below.

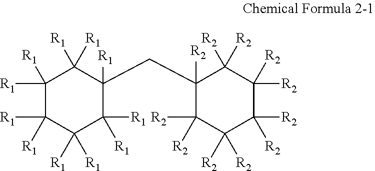

In Chemical Formula 2-1,

The R₁ radicals may be identical or different and may each independently be hydrogen, halogen, a C1 to C10 alkyl group, or an isocyanate group, and at least one of R₁ may be or include an isocyanate group.

The R₂ radicals may be identical or different and may each independently be hydrogen, halogen, a C1 to C10 alkyl group, or an isocyanate group, and at least one of R₂ may be or include an isocyanate group.

In an example embodiment, Chemical Formula 2 above may be represented by Chemical Formula 2-2 below.

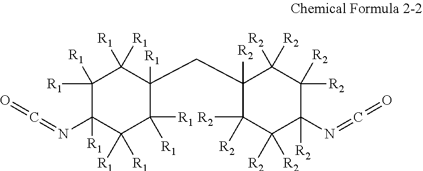

In Chemical Formula 2-2,

The R₁ radicals may be identical or different and may independently be hydrogen, halogen, or a C1 to C10 alkyl group.

The R₂ radicals may be identical or different and may each independently be hydrogen, halogen, or a C1 to C10 alkyl group.

An amount of the first compound represented by Chemical Formula 1 may be about 0.01 parts by weight to about 5.0 parts by weight relative to 100 parts by weight of the electrolyte for a rechargeable lithium battery. For example, an amount of the additive may be about 0.05 parts by weight to about 3 parts by weight or about 0.05 parts by weight to about 1 part by weight relative to 100 parts by weight of the electrolyte for a rechargeable lithium battery. The amount of the first compound may refer to a weight of the first compound included in the total weight of the electrolyte. When the amount of the first compound falls within any of the ranges above, it may be possible to increase or maximize effect of reducing or suppressing a resistance increase rate, and improving battery lifetime characteristics.

An amount of the second compound represented by Chemical Formula 2 may be about 0.05 parts by weight to about 10 parts by weight relative to 100 parts by weight of the electrolyte for a rechargeable lithium battery. For example, an amount of the additive may be about 0.05 parts by weight to about 3 parts by weight or about 0.05 parts by weight to about 1 part by weight relative to 100 parts by weight of the electrolyte for a rechargeable lithium battery. The amount of the second compound may refer to a weight of the second compound included in the total weight of the electrolyte. When the amount of the second compound falls within any of the ranges above, it may be possible to improve or maximize the effect of reducing or suppressing a resistance increase rate, and improving battery lifetime characteristics.

An amount of the additive may be about 0.01 parts by weight to about 20 parts by weight relative to 100 parts by weight of the electrolyte for a rechargeable lithium battery. For example, the amount of the additive may be about 0.1 parts by weight to about 15 parts by weight, or about 0.1 parts by weight to about 13 parts by weight relative to 100 parts by weight of the electrolyte for a rechargeable lithium battery.

The additive may include the first compound and the second compound in a weight ratio of about 1:0.01 to about 1:10. For example, the additive may include the first compound and the second compound in a weight ratio of about 1:0.01 to about 1:8 or about 1:0.01 to about 1:6.

The first compound represented by Chemical Formula 1 may be reduced on a surface of the negative electrode, thereby protecting the negative electrode. In addition, the first compound may reduce or suppress the reduction of transition metal, which is eluted from the positive electrode, at a negative electrode interface. Through these functions, the first compound may improve stability of SEI (solid electrolyte interface) and reduce or prevent the generation of lithium dendrites.

The second compound represented by Chemical Formula 2 may function to control moisture, and to reduce or suppress side reactions caused by transition metals eluted from the positive electrode.

The first compound represented by Chemical Formula 1 and the second compound represented by Chemical Formula 2 may produce a synergic effect when used simultaneously or contemporaneously. For example, more desired or advantageous effects may be achieved when the first and second compounds are mixed and added to satisfy the amount range of the present disclosure than when any single one of the first and second compounds is added alone.

These effects of the additive including the first compound and the second compound may become pronounced when used with a positive electrode active material including at least one of a lithium iron phosphoric-based positive electrode active material and a lithium nickel-based positive electrode active material.

### Rechargeable Lithium Battery

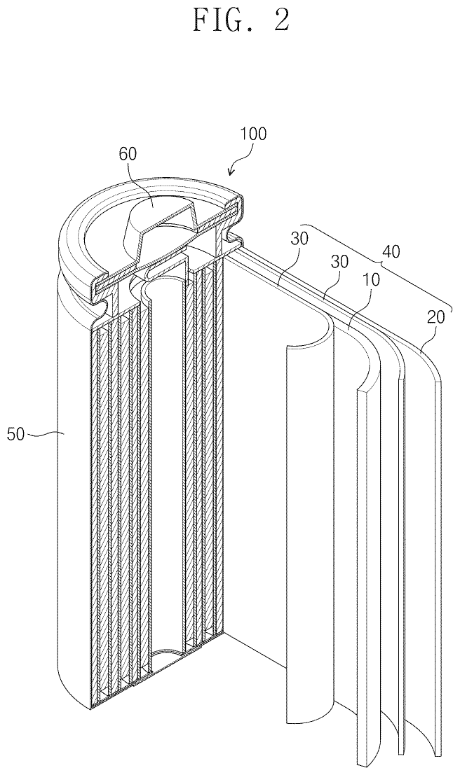

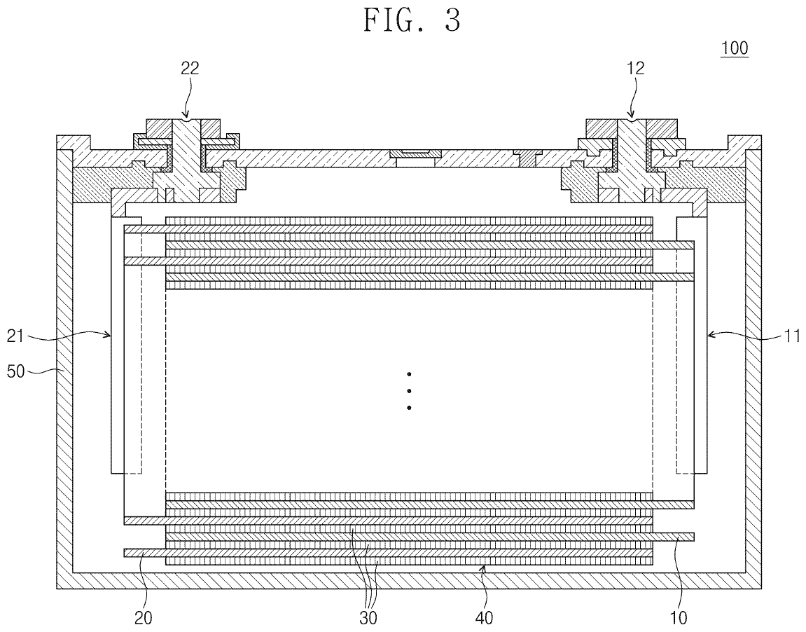

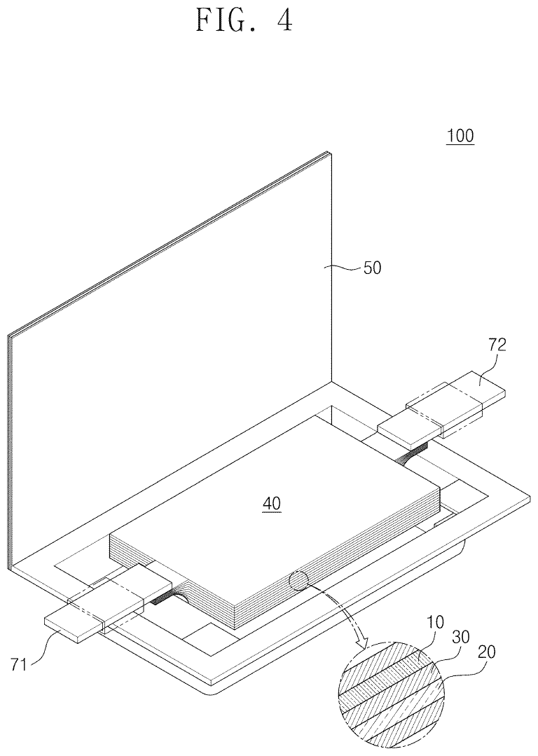

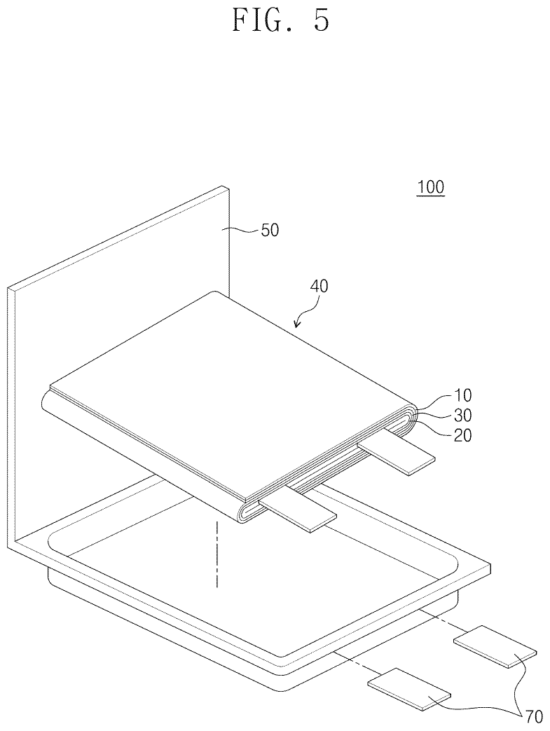

Based on the shape of a rechargeable lithium battery, the rechargeable lithium battery may be classified into cylindrical, prismatic, pouch, and coin types. FIGS. 2 to 5 illustrate simplified diagrams showing a rechargeable lithium battery according to an example embodiment, with FIG. 2 showing a cylindrical battery, FIG. 3 showing a prismatic battery, and FIGS. 4 and 5 showing pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tab 70/71/72 forming an electrical path for externally inducing a current generated in the electrode assembly 40 from the battery 100.

The rechargeable lithium battery according to an example embodiment of the present disclosure may be applicable to, e.g., automotive vehicles, mobile phones, and/or any other electrical devices, but the present disclosure is not limited thereto.

A rechargeable lithium battery according to the present disclosure may include a positive electrode including a positive electrode active material, a negative electrode including a negative electrode active material, and the aforementioned electrolyte for the rechargeable lithium battery.

The positive electrode active material may include a lithium composite oxide represented by Chemical Formula 3 below.

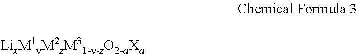

In Chemical Formula 3, x, y, z, and “a” may satisfy the relationship of 0.5≤x≤1.8, 0≤a≤0.05, 0<y≤1, 0≤z≤1, and 0≤y+z≤1.

M¹, M², and M³ may each independently include at least one metal such as at least one of Ni, Co, Mn, Al, B, Ba, Ca, Ce, Cr, Fe, Mo, Nb, Si, Sr, Mg, Ti, V, W, Zr, La, and a combination thereof.

X may include at least one element such as at least one of F, S, P, and Cl.

In an example embodiment, the positive electrode active material may include at least one of a lithium iron phosphate-based positive electrode active material, and a lithium nickel-based positive electrode active material. The lithium iron phosphate-based positive electrode active material may include at least one of Fe and P. The lithium nickel-based positive electrode active material may include Ni.

In an example embodiment, in Chemical Formula 3, M¹ may be or include Fe, and X may be or include P. Alternatively, in Chemical Formula 3, M¹ may be or include Ni, M² may be or include Co, and M³ may be or include Al. In another example, in Chemical Formula 3, M¹ may be or include Ni, M² may be or include Co, and M³ may be or include Mn.

The negative electrode active material may be or include a carbon-based negative electrode active material, a Si-based negative electrode active material, a Sn-based negative electrode active material, or a combination thereof.

In an example embodiment, the Si-based negative electrode active material may be or include a silicon-carbon composite.

In the rechargeable lithium battery according to an example embodiment of the present disclosure, a non-aqueous electrolyte may decompose during an initial charge-discharge to form a film having passivation ability on the surfaces of the positive and negative electrodes to improve high-temperature storage characteristics. The film may deteriorate due to acid such as HF⁻ and PF₅⁻ produced by thermal decomposition of lithium salts (LiPF₆ and the like) widely used in lithium ion batteries. This acid attack may elute transition metal elements from the positive electrode, and may increase a surface resistance of the electrode caused by a structural change of the surface. Thus, a theoretical capacity may be reduced due to loss of metal elements which are redox (reduction and oxidation) centers, which may result in a reduction in capacity. In addition, the eluted transition metal ions may be electrodeposited on the negative electrode that reacts in a strong reduction potential range. Therefore, electrons may be consumed and the film may be destroyed during the electrodeposition, and accordingly, the surface of the negative electrode may be exposed which may cause an additional electrolyte decomposition reaction. There may thus be an increase in resistance of the negative electrode and in irreversible capacity, and as a result, there may be a problem of continuous or substantial reduction in cell capacity.

In the present disclosure, the first compound represented by Chemical Formula 1 and the second compound represented by Chemical Formula 2 may stabilize the SEI, reduce or prevent the generation of lithium dendrites, and reduce or suppress the side reaction of transition metal eluted from the positive electrode. As a result, the problems mentioned above may be mitigated to achieve effects such as reduction or suppression of resistance increase rate and improvement of battery lifetime characteristics. The effects may become more pronounced at high temperatures.

The following will describe example embodiments and comparative examples of the present disclosure. The following example embodiments, however, are merely exemplary, and the present disclosure is not limited to the example embodiments discussed below.

### Example Embodiment 1

### (1) Preparation of Electrolyte

1.5M LiPF₆ was dissolved in a non-aqueous organic solvent containing

ethylene carbonate (EC), ethylmethyl carbonate (EMC), and dimethyl carbonate (DMC) mixed in a volume ratio of about 20:40:40, and an additive was added to prepare an electrolyte.

The additive may include a first compound in an amount of 0.1 parts by weight relative to 100 parts by weight of the electrolyte and a second compound in an amount of 0.5 parts by weight relative to 100 parts by weight of the electrolyte.

A material represented by Chemical Formula 1 below was used as the first compound, and a material represented by Chemical Formula 2-3 below was used as the second compound.

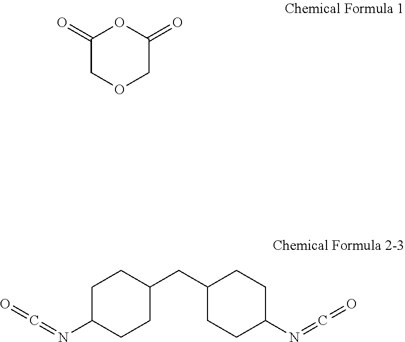 [SMILES: O=C1COCC(=O)O1 ; O=C=NC1CCC(CC2CCC(N=C=O)CC2)CC1]

### (2) Fabrication of Rechargeable Lithium Battery

LiFePO₄ as a positive electrode active material, polyvinylidene fluoride as a binder, and Ketjen black as a conductive material were mixed in a weight ratio of 96:3:1, and the mixture was dispersed in N-methylpyrrolidone to prepare a positive electrode active material slurry.

The positive electrode active material slurry was coated on an aluminum current collector of 15 μm in thickness, dried at 100° C., and subsequently pressed to manufacture a positive electrode.

Artificial graphite as a negative electrode active material, a styrene-butadiene rubber (SBR) binder, and carboxymethyl cellulose (CMC) as a thickener were mixed in a weight ratio of 98:1:1, and the mixture was dispersed in distilled water to prepare a negative electrode active material slurry.

The negative electrode active material slurry was coated on a copper current collector of 10 μm in thickness, dried at 100° C., and subsequently pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Example Embodiment 2

An electrolyte and a rechargeable lithium battery were fabricated in the same method as in Example Embodiment 1, with a difference that the additive included the first compound in an amount of 0.3 parts by weight relative to 100 parts by weight of the electrolyte and the second compound in an amount of 0.5 parts by weight relative to 100 parts by weight of the electrolyte.

### Example Embodiment 3

An electrolyte and a rechargeable lithium battery were fabricated in the same method as in Example Embodiment 1, with a difference that the additive included the first compound in an amount of 0.5 parts by weight relative to 100 parts by weight of the electrolyte and the second compound in an amount of 0.5 parts by weight relative to 100 parts by weight of the electrolyte.

### Example Embodiment 4

An electrolyte and a rechargeable lithium battery were fabricated in the same method as in Example Embodiment 1, with a difference that the additive included the first compound in an amount of 1.0 part by weight relative to 100 parts by weight of the electrolyte, and the second compound in an amount of 0.5 parts by weight relative to 100 parts by weight of the electrolyte.

### Comparative Example 1

An electrolyte and a rechargeable lithium battery were fabricated in the same method as in Example Embodiment 1, with a difference that the additive did not include any of the first compound and the second compound.

### Comparative Example 2

An electrolyte and a rechargeable lithium battery were fabricated in the same method as in Example Embodiment 1, with a difference that the additive did not include the first compound and included the second compound in an amount of 0.5 parts by weight relative to 100 parts by weight of the electrolyte.

### Comparative Example 3

An electrolyte and a rechargeable lithium battery were fabricated in the same method as in Example Embodiment 1, with a difference that the additive included the first compound in an amount of 0.5 parts by weight relative to 100 parts by weight of the electrolyte and did not include the second compound.

### Comparative Example 4

An electrolyte and a rechargeable lithium battery were fabricated in the same method as in Example Embodiment 1, with a difference that the additive included the first compound in an amount of 4 parts by weight relative to 100 parts by weight of the electrolyte and the second compound in an amount of 0.5 parts by weight relative to 100 parts by weight of the electrolyte.

### Comparative Example 5

An electrolyte and a rechargeable lithium battery were fabricated in the same method as in Example Embodiment 1, with a difference that the additive included a compound A represented by Chemical Formula 4 in an amount of 0.5 parts by weight relative to 100 parts by weight of the electrolyte and the second compound in an amount of 0.5 parts by weight relative to 100 parts by weight of the electrolyte.

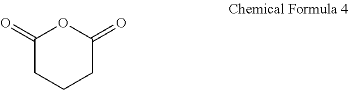

### Comparative Example 6

An electrolyte and a rechargeable lithium battery were fabricated in the same

method as in Example Embodiment 1, with a difference that the additive included a compound B represented by Chemical Formula 5 in an amount of 0.5 parts by weight relative to 100 parts by weight of the electrolyte and the second compound in an amount of 0.5 parts by weight relative to 100 parts by weight of the electrolyte.

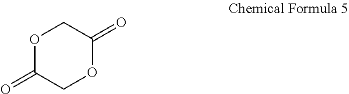

### Comparative Example 7

An electrolyte and a rechargeable lithium battery were fabricated in the same method as in Example Embodiment 1, with a difference that the additive included a compound C represented by Chemical Formula 6 in an amount of 0.5 parts by weight relative to 100 parts by weight of the electrolyte and the second compound in an amount of 0.5 parts by weight relative to 100 parts by weight of the electrolyte.

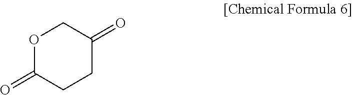

### Comparative Example 8

An electrolyte and a rechargeable lithium battery were fabricated in the same method as in Example Embodiment 1, with a difference that the additive included a compound D represented by Chemical Formula 7 in an amount of 0.5 parts by weight relative to 100 parts by weight of the electrolyte and the second compound in an amount of 0.5 parts by weight relative to 100 parts by weight of the electrolyte.

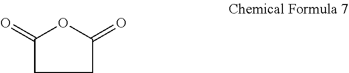

### Evaluation 1: Room-Temperature Lifetime

A room-temperature capacity retention rate was measured to evaluate room-temperature lifetime characteristics. A rechargeable lithium battery was charged and discharged at 25° C. for 400 cycles under the condition of 0.33 C charge (CC/CV, 3.6V, 0.025 C cut-off) and 1.0 C discharge (CC, 2.5V cut-off). The results are listed in Table 1. A capacity retention rate was calculated according to Equation 1 below.

$$Capacity retention rate ( \% ) = ( discharge capacity after 400 cycles / discharge capacity after 1 cycle ) \times 100 \qquad Equation 1$$

### Evaluation 2: High-Temperature Lifetime

A high-temperature capacity retention rate was measured to evaluate high-temperature lifetime characteristics. A rechargeable lithium battery was charged and discharged at 45° C. for 400 cycles under the condition of 0.33 C charge (CC/CV, 3.6V, 0.025 C cut-off) and 1.0 C discharge (CC, 2.5V cut-off). The results are listed in Table 1. A capacity retention rate was calculated according to Equation 1 above.

### Evaluation 3: Resistance Increase Rate during High-Temperature Storage

Rechargeable lithium batteries fabricated in Example Embodiments and Comparative Example were charged at room temperature (25° C.) to SOC 100% under the condition of constant current-constant voltage (CC/CV), 0.33 C, 3.6V, and 1.0 C Cut-off, and an initial battery resistance (DC-IR) and a battery resistance (DC-IR) after storage at 60° C. for 60 days were subsequently measured. A resistance increase rate was measured and the result is listed in Table 1 below. A resistance (DC-IR), which is calculated from a difference in current and voltage when different currents are applied, was obtained with Ohm's law ΔR=ΔV/ΔI after being discharged at 1 C for 30 seconds in an initial full charge state. The resistance increase rate was calculated according to Equation 2 below.

$$Resistance increase rate ( \% ) = \{ ( resistance after 60 days / initial resistance ) - 1 \} \times 100 \qquad Equation 2$$

TABLE 1

| | | | | Evaluation result | | | | |
|---|---|---|---|---|---|---|---|---|
| | Amount | | | Lifetime | | Resistance increase rate | | |
| | Chemical | Chemical | | Room-temperature | High-temperature | | Resistance | Resistance |
| | Formula | Formula | Chemical | capacity | capacity | Initial | after 60 | increase |
| | 1 | 2-3 | Formula, | retention rate | retention rate | resistance | days | rate |
| | (wt %) | (wt %) | (wt %) | (%) | (%) | (mΩ) | (mΩ) | (%) |
| Example | 0.1 | 0.5 | — | 77.9 | 73.3 | 42.12 | 64.74 | 153.7 |
| Embodiment 1 | | | | | | | | |
| Example | 0.3 | 0.5 | — | 86.4 | 74.9 | 41.67 | 59.38 | 142.5 |
| Embodiment 2 | | | | | | | | |
| Example | 0.5 | 0.5 | — | 91.1 | 82.6 | 40.15 | 52.92 | 131.8 |
| Embodiment 3 | | | | | | | | |
| Example | 1.0 | 0.5 | — | 88.7 | 76.5 | 44.51 | 66.68 | 149.8 |
| Embodiment 4 | | | | | | | | |
| Comparative | 0 | 0 | — | 75.4 | 69.7 | 42.38 | 69.25 | 163.4 |
| Example 1 | | | | | | | | |
| Comparative | 0 | 0.5 | — | 83.2 | 76.8 | 41.86 | 62.58 | 149.5 |
| Example 2 | | | | | | | | |
| Comparative | 0.5 | 0 | — | 76.5 | 74.3 | 42.03 | 63.81 | 151.8 |
| Example 3 | | | | | | | | |
| Comparative | 4 | 0.5 | — | 87.3 | 75.1 | 45.89 | 68.97 | 150.3 |
| Example 4 | | | | | | | | |
| Comparative | — | 0.5 | Chemical | 87.8 | 78.3 | 40.56 | 56.66 | 139.7 |
| Example 5 | | | Formula 4 | | | | | |
| | | | (0.5) | | | | | |
| Comparative | — | 0.5 | Chemical | 86.6 | 76.8 | 41.11 | 57.76 | 140.5 |
| Example 6 | | | Formula 5 | | | | | |
| | | | (0.5) | | | | | |
| Comparative | — | 0.5 | Chemical | 82.3 | 74.4 | 41.49 | 62.28 | 150.1 |
| Example 7 | | | Formula 6 | | | | | |
| | | | (0.5) | | | | | |
| Comparative | — | 0.5 | Chemical | 84.9 | 75.6 | 42.10 | 62.52 | 148.5 |
| Example 8 | | | Formula 7 | | | | | |
| | | | (0.5) | | | | | |

Referring to Table 1, compared to Comparative Examples, Example Embodiments according to the present disclosure have high room-temperature capacity retention rate, increased high-temperature capacity retention rate, and low resistance increase rate. For example, desired or advantageous effects of improving battery lifetime characteristics and reducing or suppressing a resistance increase rate are achieved in the cases which use an electrolyte including a combination of the first compound and the second compound.

An electrolyte for a rechargeable lithium battery according to an example embodiment may reduce or suppress a resistance increase rate and may improve battery lifetime characteristics. The effects may become more pronounced at high temperatures.

While this disclosure has been described in connection with what is presently considered to be example embodiments, it is to be understood that the present disclosure is not limited to the disclosed example embodiments and is intended to cover various modifications and equivalent arrangements included within the spirit and scope of the appended claims, and therefore the aforementioned example embodiments should be understood to be exemplarily but not limiting this disclosure in any way.

What is claimed is:

1. An electrolyte for a rechargeable lithium battery, the electrolyte comprising:
a non-aqueous organic solvent;
a lithium salt; and
an additive,
wherein the additive includes a first compound represented by Chemical Formula 1 and a second compound represented by Chemical Formula 2, 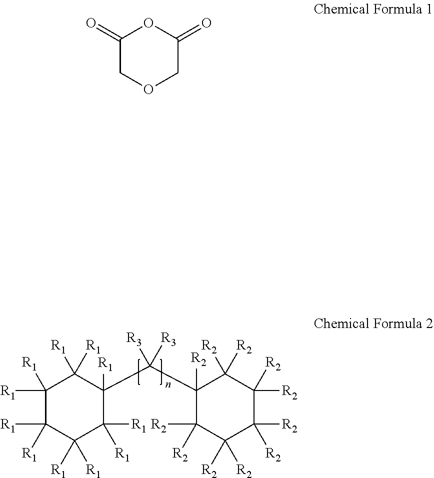
wherein, in Chemical Formula 2,
R₁ radicals are identical or different from each other, and each independently comprise one of hydrogen, halogen, a C1 to C10 alkyl group, and an isocyanate group, at least one of R₁ comprises an isocyanate group,
R₂ radicals are identical or different from each other, and each independently comprise one of hydrogen, halogen, a C1 to C10 alkyl group, and an isocyanate group,
at least one of R₂ comprises an isocyanate group,
R₃ radicals are identical or different from each other, and each independently comprise one of hydrogen and a cyclohexyl isocyanate residue, and
n is an integer in a range of 1 to 10.

2. The electrolyte of claim 1, wherein Chemical Formula 2 is represented by Chemical Formula 2-1, 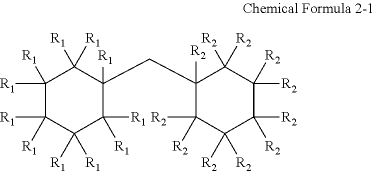
wherein, in Chemical Formula 2-1,
R₁ radicals are identical or different from each other, and each independently comprise one of hydrogen, halogen, a C1 to C10 alkyl group, and an isocyanate group,
at least one of R₁ comprises an isocyanate group,
R₂ radicals are identical or different from each other, and each independently comprise one of hydrogen, halogen, a C1 to C10 alkyl group, and an isocyanate group, and
at least one of R₂ comprises an isocyanate group.

3. The electrolyte of claim 1, wherein Chemical Formula 2 is represented by Chemical Formula 2-2, 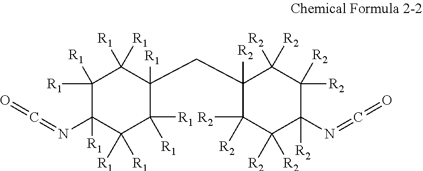
wherein, in Chemical Formula 2-2,
R₁ radicals are identical or different from each other, and each independently comprise one of hydrogen, halogen, and a C1 to C10 alkyl group, and
R₂ radicals are identical or different from each other, and each independently comprise one of hydrogen, halogen, and a C1 to C10 alkyl group.

4. The electrolyte of claim 1, wherein an amount of the first compound is about 0.05 parts by weight to about 3 parts by weight relative to 100 parts by weight of the electrolyte for the rechargeable lithium battery.

5. The electrolyte of claim 1, wherein an amount of the first compound is about 0.05 parts by weight to about 1 part by weight relative to 100 parts by weight of the electrolyte for the rechargeable lithium battery.

6. The electrolyte of claim 1, wherein an amount of the second compound is about 0.05 parts by weight to about 10 parts by weight relative to 100 parts by weight of the electrolyte for the rechargeable lithium battery.

7. The electrolyte of claim 1, wherein an amount of the second compound is about 0.05 parts by weight to about 3 parts by weight relative to 100 parts by weight of the electrolyte for the rechargeable lithium battery.

8. The electrolyte of claim 1, wherein an amount of the second compound is about 0.05 parts by weight to about 1 part by weight relative to 100 parts by weight of the electrolyte for the rechargeable lithium battery.

9. The electrolyte of claim 1, wherein an amount of the additive is about 0.1 parts by weight to about 13 parts of weight relative to 100 parts by weight of the electrolyte for the rechargeable lithium battery.

10. The electrolyte of claim 1, wherein the additive comprises the first compound and the second compound in a weight ratio of about 1:0.01 to about 1:6.

11. The electrolyte of claim 1, wherein the non-aqueous organic solvent comprises a carbonate-based solvent.

12. The electrolyte of claim 1, wherein the non-aqueous organic solvent comprises at least one of ethylene carbonate (EC), ethylmethyl carbonate (EMC), and dimethyl carbonate (DMC).

13. The electrolyte of claim 12, wherein the ethylene carbonate (EC), the ethylmethyl carbonate (EMC), and the dimethyl carbonate (DMC) have a volume ratio of 1:a:b,
wherein “a” is about 1 to about 3, and
wherein “b” is about 1 to about 3.

14. The electrolyte of claim 1, wherein the lithium salt comprises LiPF₆.

15. The electrolyte of claim 1, wherein a concentration of the lithium salt is in a range of about 0.1 M to about 2.0 M.

16. A rechargeable lithium battery, comprising:
a positive electrode that includes a positive electrode active material;
a negative electrode that includes a negative electrode active material; and
the electrolyte for the rechargeable lithium battery as set forth in claim 1.

17. The rechargeable lithium battery of claim 16, wherein the positive electrode active material comprises lithium composite oxide represented by Chemical Formula 3, 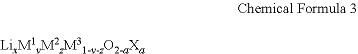
wherein 0.5≤x≤1.8, 0≤a≤0.05, 0<y≤1, 0≤z≤1, and 0≤y+z≤1,
wherein M¹, M², and M³ each independently comprises at least one of Ni, Co, Mn, Al, B, Ba, Ca, Ce, Cr, Fe, Mo, Nb, Si, Sr, Mg, Ti, V, W, Zr, La, and a combination thereof, and
wherein X comprises at least one of F, S, P, and Cl.

18. The rechargeable lithium battery of claim 17, wherein, in the positive electrode active material,
M¹ comprises Fe, and
X comprises P.

19. The rechargeable lithium battery of claim 16, wherein the positive electrode active material comprises at least one of a lithium iron phosphate-based positive electrode active material and a lithium nickel-based positive electrode active material.

20. The rechargeable lithium battery of claim 16, wherein the negative electrode active material comprises at least one of a carbon-based negative electrode active material, a Si-based negative electrode active material, and a Sn-based negative electrode active material.
